(19) United States
(12) Patent Application Publication
(10) Pub. No.: US 2026/0119088 A1
(43) Pub. Date: Apr. 30, 2026

(54) METHODS FOR INTELLIGENT COLOR REPRODUCTION FOR IMPOSED DOCUMENTS

(71) Applicant: Kyocera Document Solutions Inc., Osaka (JP)

(72) Inventors: Javier A. MORALES, Rochester, NY (US); Michelle de BEUS, Redondo Beach, CA (US)

(73) Assignee: Kyocera Document Solutions Inc., Osaka (JP)

(21) Appl. No.: 18/933,505

(22) Filed: Oct. 31, 2024

(51) Int. Cl. G06F 3/12

(52) U.S. Cl. CPC G06F 3/1208; G06F 3/1253

(57) ABSTRACT

A printing system includes a printing device having a digital front end (DFE). The DFE communicates with a cloud server system within the printing system. The printing system is configured to print imposed pages having pages or documents having output intents. A first page of the imposed page has a first output intent. A second page of the imposed page has a second output intent. The first output intent relates to a first gamut applicable to color printing the first page. The second output intent relates to a second gamut applicable to color printing the second page. A page-level output intent for the imposed is set to the first output intent or the second output intent based on an evaluation of the first gamut and the second gamut.

### FIELD OF THE INVENTION

The present invention relates to methods for managing printing operations having intelligent color reproduction for imposed documents. More particularly, the present invention relates to the use of multiple output intents on imposed documents in an intelligent manner.

### DESCRIPTION OF THE RELATED ART

Documents, such as those having the portable document format (PDF), define an output intent in order to override working spaces when performing color conversion. This action ensures that colors are reproduced accurately. For example, PDF version 1 may support the use of a single output intent for a PDF document. PDF version 2 and later versions may support the use of different output intents for each page in the PDF document. While the enhancements in PDF version 2 may close significant gaps in quality color reproduction, the functionality still falls short of what is needed in order to provide accurate color management in production workflows.

For example, the above enhancements may not consider that if a document is imposed in any manner other than repeated, then the imposed sheet may end up having a page that contains that themselves may use different output intents. This result also may happen in situations where jobs are grouped in that different PDFs are added to the same imposed page as each PDF may have its own global or page-specific output intents.

### SUMMARY OF THE INVENTION

A method for managing color printing operations within a printing system is disclosed. The method includes determining that a print job received in the printing system includes page-level output intents for a plurality of pages within the print job. The method also includes detecting an imposed page of the plurality of pages within the print job. The imposed page includes a first page and a second page of the plurality of pages. The method also includes determining a first page-level output intent for the first page or a second page-level output intent for the second page differs from an overall output intent for the print job. The method also includes evaluating a first gamut associated with the first page-level output intent and a second gamut associated with the second page-level output intent. The method also includes setting a page-level output intent for the imposed page to the first page-level output intent or the second page-level output intent based on the evaluation.

In additional embodiments, the method also includes determining the imposed page includes multiple output intents. The method further includes embedding the first page and the second page in a transparency group. The method further includes setting an output intent for the first page and the second page as a color space for the transparency group.

In additional embodiments, the method also includes determining a number of colors that overlap between the first page-level output intent and the second page-level output intent. The method further includes, if the number of colors that overlap do not exceed a defined threshold, comparing the first page-level output intent and the second page-level output intent to specified ICC profiles. The method further includes setting the page-level output intent for the imposed page to a color space that includes the first page-level output intent and the second page-level output intent.

In additional embodiments, the method also includes tracking the first page and the second page based on the first page-level output intent and the second page-level output intent, respectively. In additional embodiments, the method also includes color printing the imposed page using the page-level output intent.

A method for managing color printing operations within a printing system is disclosed. The method includes determining that a print job received in the printing system includes page-level output intents for a plurality of pages within the print job. The method also includes determining a page-level output intent for a page differs from an overall output intent for the print job. The method also includes evaluating a gamut associated with the page-level output intent and a gamut associated with the overall output intent. The method also includes setting the page-level output intent for the page to the overall output intent if the gamut associated with the overall output intent is greater than the gamut associated with the page-level output intent.

In additional embodiments, the method also includes discarding the page-level output intent for the page if it does not differ from the overall output intent.

In additional embodiments, the method also includes detecting an imposed page of the plurality of pages within the print job. The imposed page includes the page. The method further includes determining the imposed page includes multiple output intents. The method further includes embedding the first page and the second page in a transparency group. The method further includes setting an output intent for the first page and the second page as a color space for the transparency group.

In additional embodiments, the method also includes printing the page using the page-level output intent.

A method for managing color printing operations within a printing system is disclosed. The method includes receiving a first print job having a first overall output intent and a second print job having a second overall output intent within the printing system. The method also includes processing an imposed page having the first print job and the second print job. The method also includes determining the first overall output intent for the first print job differs from the second overall output intent for the second print job. The method also includes evaluating a first gamut associated with the first overall output intent and a second gamut associated with the second overall output intent. The method also includes setting a page-level output intent for the imposed page to the first overall output intent or the second overall output intent based on the evaluation.

In additional embodiments, the method also includes determining a number of colors that overlap between the first overall output intent and the second overall output intent. The method further includes, if the number of colors that overlap do not exceed a defined threshold, comparing the first overall output intent and the second overall output intent to specified ICC profiles. The method further includes setting the page-level output intent for the imposed page to a color space that includes the first overall output intent and the second overall output intent.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a paper catalog for use within the printing system according to the disclosed embodiments.

FIG. 4 illustrates a color conversion system for use with the printing system according to the disclosed embodiments.

FIG. 5 illustrates a flow diagram for processing an imposed page according to the disclosed embodiments.

FIG. 6 illustrates a flow diagram for processing an imposed page having a first print job and a second print job according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a system that intelligently processes PDF output intents in order to ensure optimal and accurate color reproduction for imposed documents. In some instances, the disclosed embodiments enable the use of multiple output intents on imposed PDFs that combine pages with different output intents.

For a single job imposition, the disclosed embodiments determine if there is a need to manage the output intents in the output file. Specifically, the disclosed embodiments may determine if the job has page-level output intents and if the job is imposed in a manner that puts different pages on the same imposed page. An example print job may be a booklet or a cut and stack imposition.

If the above conditions are true, then the disclosed embodiments may track the pages that have a page-level output intent. Some, but not all, pages may have a page-level output intent. The disclosed embodiments also may track which pages end up combined into the same imposed page. The disclosed embodiments also then will determine if one or more pages in the layout have a page-level output intent.

If there is a single page that has a page-level output intent, then the disclosed embodiments may determine if this output intent is different as compared to the overall output intent. If these are the same, then the disclosed embodiments will do nothing. The page-level output intent may be discarded. If these are different, then the disclosed embodiments will resolve the output intent differences according to one or more disclosed processes.

If the imposed sheet has multiple output intents, then the disclosed embodiments may embed each PDF page in a transparency groups and set the output intent of the page as the color space for the transparency group. During color conversion, transparency groups are converted to their color space before they are converted to the output intent of the page. The disclosed embodiments may also evaluate the gamut, or three-dimensional (3D) space, of the output intents for the pages that will be combined into a single imposed page. The disclosed embodiments may select the output intent with the largest gamut and use that as the page-level output intent for the imposed page.

The disclosed embodiments may, optionally, determine the overlap between the different page-level output intents that will be combined in the imposed PDF page. If the number of colors that do not exceed a defined threshold, then the disclosed embodiments may compare all the page-level output intents against industry standard ICC profiles to cover both gamuts. The disclosed embodiments then set the page-level output intent for the imposed page to an industry-standard color space that may contain the page-level output intents for all imposed pages. The features disclosed above ensure that there is no clipping when the converted transparent groups are converted to the output intent for the imposed page.

The output of the disclosed processes should be an imposed PDF having imposed sheets. The imposed sheets that combine pages having different output intents and only those pages are embedded into transparency groups to ensure the most accurate color reproduction for each page in the imposed sheet.

Further, the disclosed embodiments may perform the same operations for grouped jobs. Grouping, or ganging, relates to when different PDFs are combined into a single imposed sheet. The grouping logic would work in the manner as disclosed above, with one exception. Because different files are combined into a single sheet, the disclosed embodiments may make it possible for pages from PDFs with different overall output intents to end up in the same sheet. As such, it may be possible to have multiple output intents in the same imposed sheet for instances in which the source files have no page-level output intents.

In some embodiments, aside for the difference on input, there may be no difference to how the disclosed embodiments would handle the combination of pages with different output intents into a single imposed sheet.

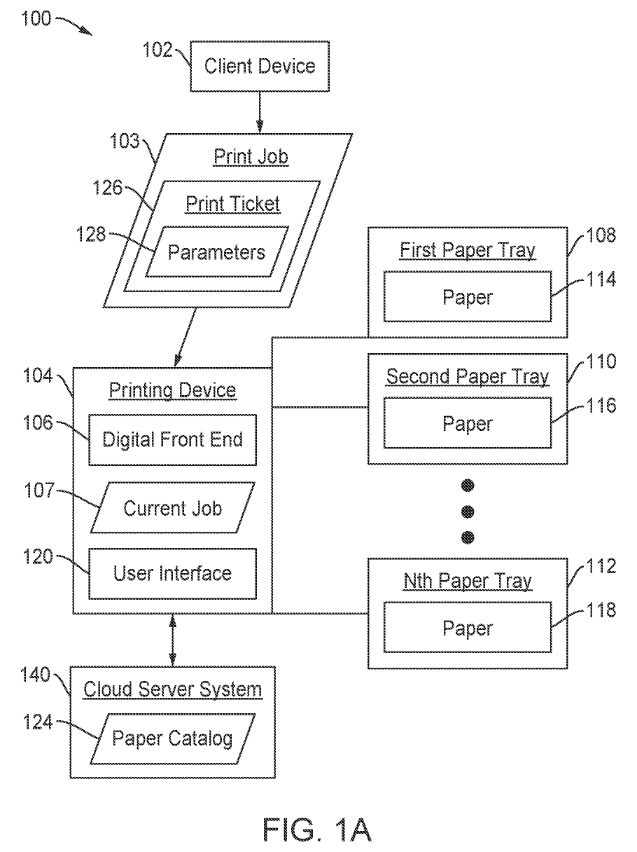

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100000 pages or more.

Print job 103 may include a print ticket 126 that sets forth one or more parameters 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more parameters 128, may be used to generate a list of recommended papers to display for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103.

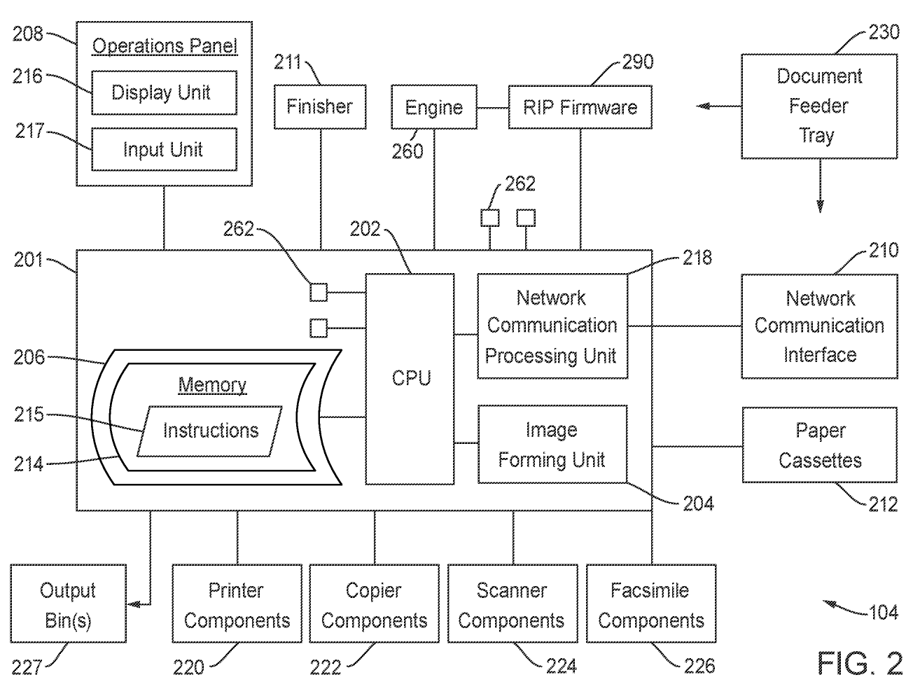

System 100 also includes cloud server system 140. Cloud server system 140 may include one or more servers that host paper catalog 124, as well as other features. Paper catalog 124 is configured to organize and store existing calibration data and ICC profiles for a plurality of papers. Upon selection of a paper for printing at printing device, paper catalog 124 may be accessed to complete print job 103 according to the expectations associated with the print job. Paper catalog 124 is disclosed in greater detail below by FIG. 3. In some embodiments, DFE 106 may include multiple paper catalogs.

In some embodiments, paper catalog 124 may be implemented within DFE 106 on printing device 104. Cloud server system 140 may still retain its own paper catalog 124 that is updated and the updates provided to a paper catalog stored by DFE 106. Paper catalog 124 is utilized for printing operations by printing device 104.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below.

Receiver 181 receives print job 103 received within system 100 and outputs the print job to RIP firmware 290. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

DFE 106 also includes processor 160 and memory storage 164. Processor 160 and memory storage 164 are connected to the other components within DFE 106. Memory storage 164 may store instructions 166, that include code that, when executed by processor 160, configures DFE 106 to perform the disclosed processes. Memory storage 164 also may store set of papers 142 received from cloud server system 140. DFE 106 may treat set of papers 142 as its own paper catalog within printing device 104. In some embodiments, information for the papers in set of papers 142 is provided to CMYK data storage 184. For example, TRCs for each paper may be provided from paper entries within set of papers 142.

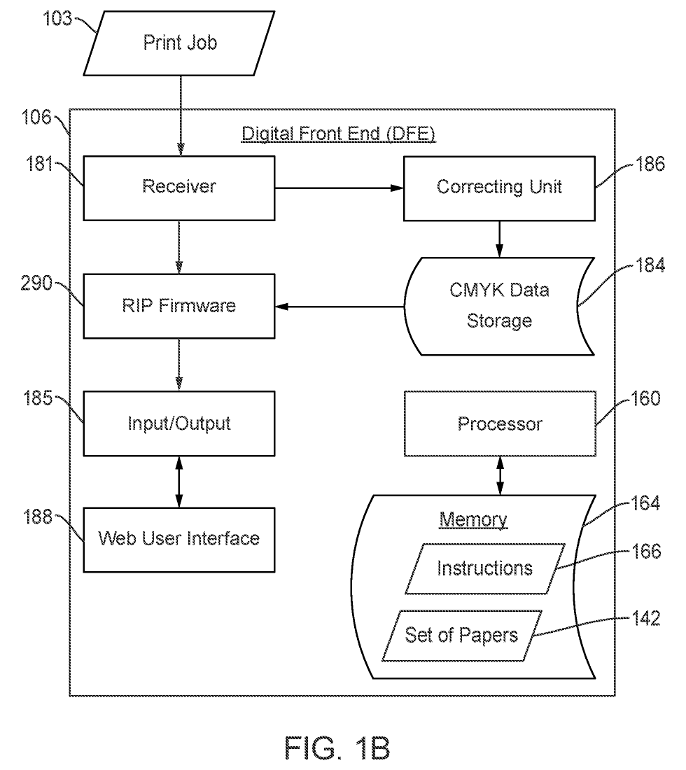

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. In some embodiments, memory unit 206 may store the tokens and codes used in performing operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

FIG. 3 depicts a block diagram of paper catalog 124 for use within printing system 100 according to the disclosed embodiments. As disclosed above, paper catalog 124 may reside within DFE 106 of printing device 104. In other embodiments, paper catalog 124 may reside in another component within printing system 100, such as client device 102 or an external server. For brevity, paper catalog 124 is disclosed below as residing within DFE 106.

For each paper type used for a particular model of printing device 104, there are a set of items that work together to achieve optimal reproduction capabilities. These items may be represented in paper catalog 124. An example of a paper catalog entry 302 in paper catalog for a paper type may be shown. Paper catalog 124 may include hundreds or thousands of such entries. Paper catalog entry 302 may be identified within paper catalog 124 by paper type identification 303. In some embodiments, paper type identification 303 may be a unique symbol or code that identifies paper catalog entry 302 within paper groups, disclosed in greater detail below.

Paper catalog entry 302 includes print conditions. Print conditions may be applied to print jobs using paper catalog entry 302. Examples of print conditions may be high quality, default, ink saving, and the like. Each print condition may include its own color printing resources, such as calibration data and ICC profiles. Application of a print condition results in a different result for a print job using paper catalog entry 302 at printing device 104. For example, a high quality print condition will differ in some fashion as a finished, printed document from one printed using the default print condition.

As shown in FIG. 3, paper catalog entry 302 may include print condition 304. It also may include additional print conditions. Print condition 304 may relate to the high quality print condition for printing paper catalog entry 302 at printing device 104. Within print condition, halftones, or halftone designs, may be defined. Printing device 104 may have one or more halftones. Halftones are binary on/off dot patterns of each ink to mimic continuously varying transitions. One halftone could emphasize details in the image, while another could be best for smooth transitions. Thus, print condition 304 includes halftone 306A and halftone 306B. For example, halftone 306A may correspond to the halftone design to emphasize details in the image being printed. Halftone 306B may correspond to the halftone design to provide for smooth transitions.

For each halftone, the print shop should capture the desired per-colorant behavior over all shades of that colorant. By behavior, the disclosed embodiments refer to the color measurement. The record of these colorant behaviors, and the information that allows printing device 104 to be adjusted back to such behaviors, are stored as calibration data. These adjustments may vary linearly or with a curve. The calibration data include characteristics of each ink under the halftone selected. Thus, halftone 306A includes calibration data 308A and halftone 306B includes calibration data 308B.

Further, with a selected halftone, and the calibration data enforced to produce desired behavior of each colorant, the disclosed embodiments then create an ICC profile to fully characterize how ink combinations relate to standardized color measurements, as disclosed above. It is via the ICC profile that, for the specific paper-halftone-calibration-data set up, printing device 104 can reproduce the colors, text, and parameters of the original document. The process for generating an ICC profile is disclosed above. Thus, halftone 306A includes ICC profile 310A and halftone 306B includes ICC profile 310B.

Often printing systems have additional “dials” for more customized controls. For instance, there are settings of total ink amounts allowed in the ICC profile for preserving the glossy finish of a paper. Alternatively, it could be a very conservative expectation of the black ink response set into the calibration data. These more specific customizations may be identified as print conditions. In the scheme of the aforementioned items affecting color management, the disclosed embodiments place print conditions at the highest tier under each paper type, as shown in FIG. 3 by print condition 304.

Paper catalog entry 302 along with print condition 304 and halftones 306A and 306B may refer to the print management resources and items for one paper type. In a print shop, for each model of printing device 104, there may be dozens or more paper types in use. To keep track of the print management items for all these papers, paper catalog 124 may be implemented in system 100. As disclosed above, paper catalog 124 may be a software data storage system that archives all the color management items and resources for each paper type in use. When a print job is specified on a particular paper, identified as paper type identification 303, under a chosen print condition 304 employing halftone 306A, paper catalog 124 will provide the proper corresponding calibration data 308A and ICC profile 310A for printing device 104 to use. If the print job specifies print condition 304 employing halftone 306B, then paper catalog 124 will provide calibration data 308B and ICC profile 310B for printing device 104 to use for the print job.

Paper catalog entry 302 also may include one or more attributes for the paper. For example, first attribute 312 may be the weight of a sheet of paper catalog entry 302. First attribute 312 may be 120 grams per square meter (gsm). Heavier paper is reflected by a higher number for gsm. Generally, heavier paper is associated with a higher quality of stock. It should be noted that dimensions may also be considered an attribute of paper catalog entry 302. Further, first attribute 312 may be considered a dimension of paper catalog entry 302.

Paper catalog entry 302 also may include second attribute 314 and third attribute 316. These attributes may pertain some other feature of the paper of paper catalog entry 302 aside from dimensions and weight. Second attribute 314 may refer to the color of the paper for paper catalog entry 302, such as white, blue, yellow, and the like. Third attribute 316 may refer to a feature of the paper of paper catalog entry 302, such as recycled, new, and the like. Other potential attributes may be glossy or matte paper.

Dimensions and attributes within paper catalog 124 may not necessarily match the attributes for paper trays 108, 110, and 112. Paper trays 108, 110, and 112 also may have attributes that apply to print job 103 as specified by print ticket 126. Dimensions may be included in print ticket 126. Dimensions also may apply to a parameter within paper catalog 124 and paper trays 108, 110, and 112. The other attributes, however, within paper catalog 124 may not apply to any attribute for paper trays 108, 110, and 112.

In some embodiments, calibrations and ICC profiles may be listed in a paper catalog entry 302 but not associated with a print condition. Further, additional print conditions may be listed for each entry. In other words, the print condition may be null within paper catalog entry 302. For example, paper catalog entry 302 may include print condition 304 as disclosed above. It also may include another set of calibration and ICC profile data, such as calibration 308A or 308B and ICC profile 310A or 310B, that is not associated with a print condition.

Paper catalog entry 302 also may include a second print condition that uses a different calibration but perhaps the same ICC profile as the sets not corresponding to a print condition. Further, paper catalog entry 302 may include another group of printing resources for halftone 306B but this is not related to a print condition and includes its own calibration and ICC profile. In other words, printing resources may be listed in a paper catalog entry 302 in a number of ways. Multiple calibrations and ICC profiles may be tied to an entry. The calibration and ICC profiles may still be tied to the integrated resource management operations disclosed herein.

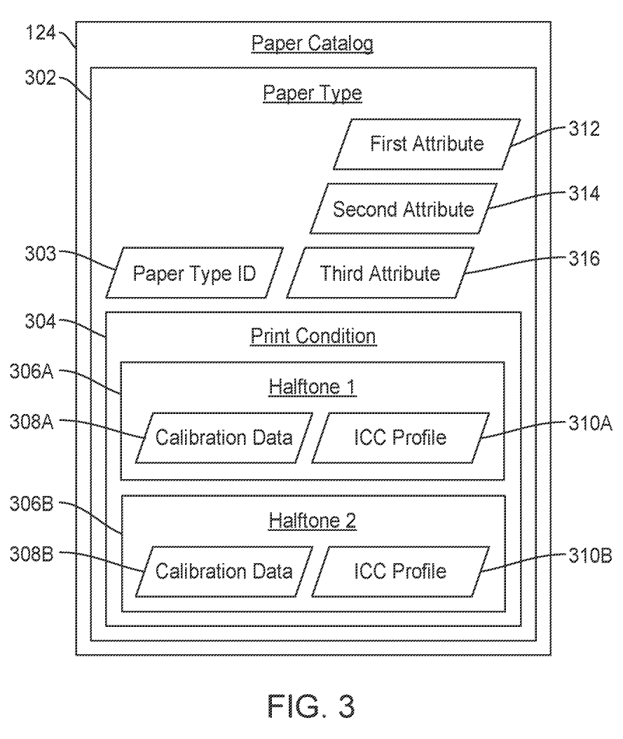

FIG. 4 depicts a color conversion system 400 for use with printing system 100 according to the disclosed embodiments. Color conversion system 400 represents a managed color workflow that offers color consistency and predictability during color conversion. As shown in FIG. 4, color conversion system 400 includes a source color space 402, a source ICC profile 404, a profile connection space (PCS) 406, destination ICC profile 457, and a destination color space 410. Color conversion system 400 may be implemented on cloud server system 140 or printing device 104.

Color conversion system 400 may be used for color conversion from a source color space 402, or colors associated with a print job, to destination color space 410, or CMYK ink combinations that a printing device can print. Color conversion system 400 seeks to reproduce the input color at the output, or printing device. Color matching occurs between different devices or numerical representations.

Color conversion system 400 may involve initially obtaining the source color space 402, which may represent colors used by a source device (e.g., a computer monitor, a scanner). Some examples of the source color space can include an RGB color space, a CMYK color space, and a CMYKOGV color space.

Color conversion system 400 further involves identifying a source ICC profile 404 that corresponds to source color space 402. Source ICC profile 404 may provide a mapping for colors within source color space 402 to PCS 406. For example, source ICC profile 404 may store one or more LUTs that can be used to map source color space 402 to the L*a*b* color space or to the XYZ color space for PCS 406. Alternatively, source ICC profile 404 can include one or more equations for mapping source color space 402 to the L*a*b* color space or to the XYZ color space for PCS 406.

PCS 406 can serve as the interface which provides an unambiguous connection between input profiles, such as source ICC profile 404, and output profiles, such as ICC profile 457 within color conversion system 400. PCS 406 can allow the profile transforms for input, display, and output devices to be decoupled so that they can be produced independently. As such, PCS 406 can serve as the virtual destination for input transforms and the virtual source for output transforms. When the input and output transforms are based on the same PCS definition, even though they are created independently, the input and output transforms can be paired arbitrarily at run time by a color-management module (CMM), such as color conversion system 400, and will yield consistent and predictable results when applied to color values.

Destination ICC profile 457 may enable mapping colors from PCS 406 to destination color space 410. In particular, destination ICC profile 457 may provide a mapping for colors within PCS 406 to destination color space 410. For example, destination ICC profile 457 may store one or more LUTs that can be used to map input colors from PCS 406, or the L*a*b* color space, to the CMYK color space associated with destination color space 410. Alternatively, destination ICC profile 457 can include one or more equations for mapping colors from PCS 406 to destination color space 410. In some instances, the selection of destination ICC profile 457 may depend on the type of printing device performing the print job using destination color space 410. Destination ICC profile 457 may correspond to the ICC profiles stored by paper catalog 124.

PCS 406 also may be related to an output intent. The output intent is the color space, such as PCS 406, into a document or page within the document should be converted to. A document may define an output intent to override a working PCS when performing color conversion. An imposed PDF may include multiple output intents. In some instances, a page may include different PDF documents having separate output intents. The disclosed embodiments provide processes that account for these situations.

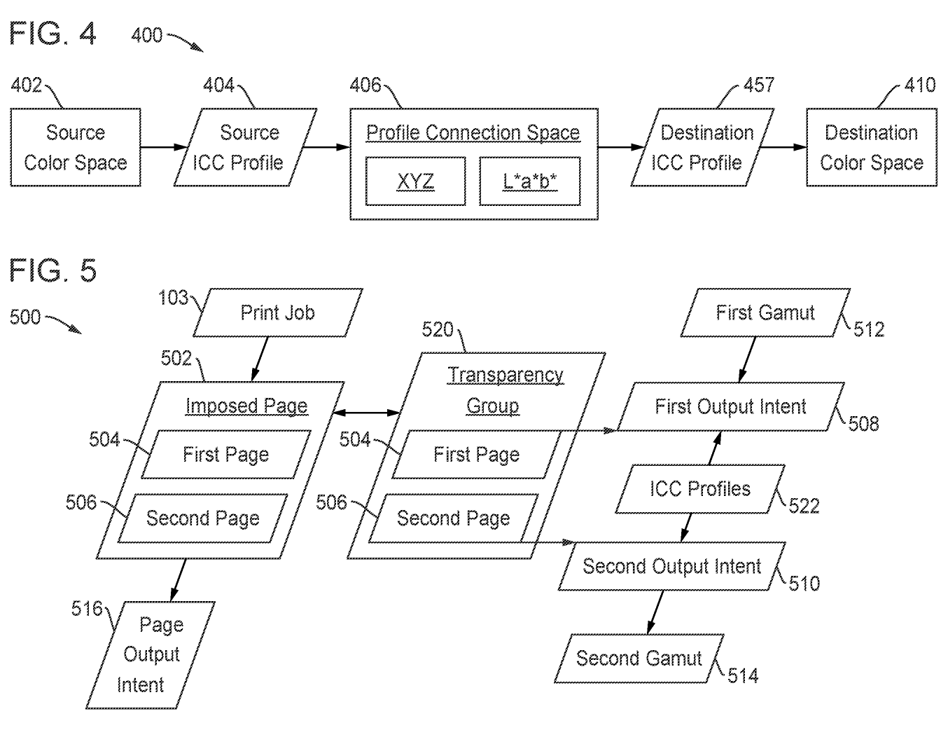

FIG. 5 depicts a flow diagram 500 for processing an imposed page 502 according to the disclosed embodiments. Print job 103 may include imposed page 502. An imposed page may relate to the arrangement of one or more pages on a sheet, or the imposed page. Imposition may be used for arranging pages for printing so that the pages are printed in the correct order. This order may help with folding or trimming the printed imposed page into the final document. This feature may reduce paper waste, simplify binding, and speed up printing.

The disclosed embodiments first determine if print job 103 include page-level output intents. The disclosed embodiments also determine if imposed page 502 for print job 103 has different pages on imposed page 502. Thus, imposed page 502 may include a first page 504 and a second page 506. Imposed page 502 may include additional pages, but two pages are shown for brevity.

As disclosed above, each separate page within imposed page 502 may have its own output intent for color reproduction of the respective page. These output intents may be known as page-level output intents. In other words, different pages within imposed page 502 may have their own output intent that corresponds to the color reproduction of the respective page. Each output intent may be used to describe the color characteristics of printing device 104 that will be used to reproduce the colors in the respective page.

First page 504, therefore, may use first output intent 508. Second page 506 may use second output intent 510. First output intent 508 is used to manage color reproduction of first page 504 by specifying PCS 406 for this page. Second output intent 510 is used to manage color reproduction of second page 506 by specifying PCS 406 for the second page. First output intent 508 may differ from second output intent 510 in that gamuts used for the output intents differ from each other. A gamut may refer to the whole range of colors available in a color printing process. It may be defined by an ICC profile used for the color reproduction of the page.

First output intent 508 may implement first gamut 512 of colors to be used for color reproduction of first page 504. Second output intent 510 may implement second gamut 514 of colors to be used for color reproduction of second page 506. Imposed page 502 also may have an output intent, shown as page output intent 516. Page output intent 516 may be defined for imposed page 502. In some embodiments, page output intent 516 may be set based on first output intent 508 and second output intent 510.

In some embodiments, it should be determined whether one or more of the page-level output intents differ from page output intent 516. The disclosed embodiments may first determine if page output intent 516 is different than first output intent 508 for first page 504 and second output intent 510 for second page 506. If the output intents are the same, then printing device 104 may print imposed page 502 with print job 103 using page output intent 516. If one or more of the page-level output intents differ from page output intent 516, then the disclosed embodiments may perform processes to properly define the page output intent for imposed page 502.

The disclosed embodiments may embed each PDF page in a transparency group. A transparency group may be a group of objects that are less than a page, such as imposed page 502, that use transparency. The objects also have a color space, such as PCS 406, into which they should be converted. The transparency group is created to allow each page, such as first page 504 and second page 506, in imposed page 502 to be converted into the original page’s output intent. During color conversion, transparency groups are converted to their color space before they are converted to the output intent of imposed page 502.

For example, each PDF page may have only a single output intent. When pages are combined that have different output intents into a single imposed page, then the disclosed embodiments should account how to retain the unique output intent for each page. The disclosed embodiments retain the output intent by putting the entire page in a transparency group. The disclosed embodiments further set the color space for the transparency group to the output intent of the page. The page’s output intent may be discarded because the same information is retained in the transparency group. The disclosed embodiments may place transparency groups into imposed page 502 and set page output intent 516 for the imposed page to the transparency group with the largest color space, or to a sufficiently large standard color space, as disclosed herein with regard to output intents 508 and 510.

Thus, first page 504 and second page 506 may be embedded in transparency group 520. Additional transparency groups may be created for imposed page 502. When color printing imposed page 502, the pages within the imposed page are converted into a single color space, or PCS 406. The transparency groups in imposed page 502 are used to retain the output intent color space for the page that was placed in the imposed page. The disclosed embodiments may convert imposed page 502 to the color space that was added as transparency group 520 and then convert those to the color space for the imposed page.

The disclosed embodiments also evaluate each gamut for the page-level output intents that are combined into imposed page 502. The disclosed embodiments may select the output intent with the largest gamut and use that for page output intent 516 for imposed page 502. For example, first gamut 512 for first output intent 508 may be larger than second gamut for second output intent 510. In other words, first output intent 508 will use a large range of color spaces than second output intent 510. As a result, first output intent 508 may be set as page output intent 516 for imposed page 502.

In some embodiments, the overlap between the different page-level output intents may be determined for the combined pages within imposed page 502. If the number of colors that do not overlap exceeds a defined threshold, then the disclosed embodiments may compare all page-level output intents against industry standard ICC profiles 522. For example, the disclosed embodiments may determine a percentage of the number of colors that do not overlap. “Overlap” may refer to colors being within a distance of each other within the color space. If they are within the distance, then the colors should overlap. The disclosed embodiments may determine the percentage of color spaces of the overall number of color spaces that overlap.

Using the above example, a defined threshold, such as 30%, may be defined. If the number of colors that do not overlap equals or exceeds 30% of the total number of colors for the gamuts of the different page-level output intents, then all the page-level output intents are compared to ICC profiles 522. The colors defined by first gamut 512 and second gamut 514 may be compared. If the number of colors that do not overlap are below 30%, then the above process may be followed in determining page output intent 516 using the largest gamut.

Alternatively, if the number of colors that do not overlap are equal or more than 30% of the colors, then the process of selecting the largest gamut may not be applicable. Thus, the disclosed embodiments may compare first output intent 508 and second output intent 510 to ICC profiles 522. ICC profiles 522 may be industry standard ICC profiles, as opposed to ICC profiles within page catalog 124. Industry standard ICC profiles usually employ large gamuts for color conversion. The ICC profile that defines a color space that can contain gamuts for the page-level output intents. The output intent for that ICC profile is set as page output intent for imposed page 502. Thus, an ICC profile 522 is identified that can cover first gamut 512 and second gamut 514. The output intent for the selected ICC profile 522 is set as page output intent 516.

The output of the above operations and processes is imposed page 502 that combines first page 504 and second page 506 that have different output intents are embedded into transparency group 520 to ensure accurate color reproduction. Printing device 104 may print imposed page 502 with the most accurate color reproduction for each page, even with different page-level output intents. It should be noted that the processes and operations disclosed by FIG. 5 may be implemented using DFE 106. Alternatively, cloud server system 140 may be configured to execute the disclosed processes and operations.

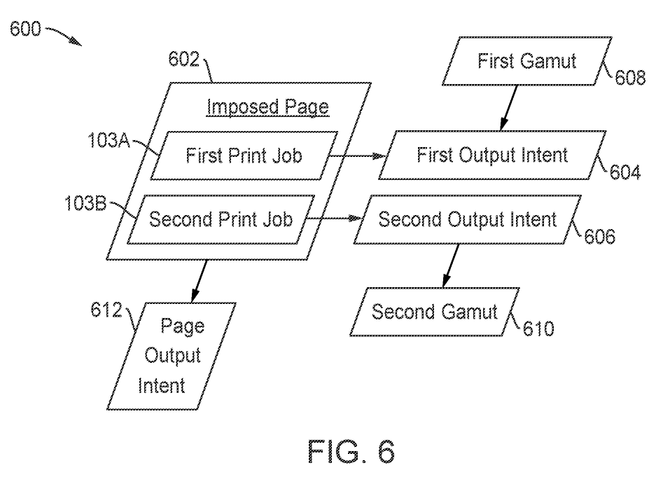

FIG. 6 depicts a flow diagram 600 for processing an imposed page 602 having a first print job 103A and a second print job 103B according to the disclosed embodiments. Imposed page 602 may be processed similar to imposed page 502. Features for processing imposed page 502 may be used in processing imposed page 602, unless disclosed differently below. Imposed page 602 may include grouped, or ganged, print jobs. This feature is when different PDFs are combined into a single imposed sheet 602.

Thus, imposed sheet 602 includes first print job 103A and second print job 103B. The print jobs may be treated in a similar manner to first page 504 and second page 506 of imposed page 502. Each print job may include different pages having different page-level output intents. An output intent for each print job may be determined using the features disclosed by FIG. 5. Thus, a first output intent 604 for first print job 103A may be determined. A second output intent 606 also is determined for second print job 103B. These output intents may be used in the disclosed analysis to determine page output intent 612 for imposed page 602.

For example, if first output intent 604 and second output intent 606 are similar, then no change may need to be made for page output intent 612. If the print job output intents are not similar, then first gamut 608 for first output intent 604 is compared to second gamut 610 for second output intent 606, as disclosed above. The largest gamut after being compared may be selected as page output intent 612 for imposed page 602. Further, if the overlap of colors between the print job output intents does not reach a certain level, then page output intent 612 may be set to an ICC profile 522. In short, the disclosed embodiments account for differences on inputs to imposed pages 502 and 602 in a similar manner.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer- usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing color printing operations within a printing system, the method comprising:
determining that a print job received in the printing system includes page-level output intents for a plurality of pages within the print job;
detecting an imposed page of the plurality of pages within the print job, wherein the imposed page includes a first page and a second page of the plurality of pages;
determining a first page-level output intent for the first page or a second page-level output intent for the second page differs from an overall output intent for the print job;
evaluating a first gamut associated with the first page-level output intent and a second gamut associated with the second page-level output intent; and
setting a page-level output intent for the imposed page to the first page-level output intent or the second page-level output intent based on the evaluation.

2. The method of claim 1, further comprising determining the imposed page includes multiple output intents.

3. The method of claim 2, further comprising embedding the first page and the second page in a transparency group.

4. The method of claim 3, further comprising setting an output intent for the first page and the second page as a color space for the transparency group.

5. The method of claim 1, further comprising determining a number of colors that overlap between the first page-level output intent and the second page-level output intent.

6. The method of claim 5, further comprising, if the number of colors that overlap do not exceed a defined threshold, comparing the first page-level output intent and the second page-level output intent to specified ICC profiles.

7. The method of claim 6, further comprising setting the page-level output intent for the imposed page to a color space that includes the first page-level output intent and the second page-level output intent.

8. The method of claim 1, further comprising tracking the first page and the second page based on the first page-level output intent and the second page-level output intent, respectively.

9. The method of claim 1, further comprising color printing the imposed page using the page-level output intent.

10. A method for managing color printing operations within a printing system, the method comprising:
determining that a print job received in the printing system includes page-level output intents for a plurality of pages within the print job;
determining a page-level output intent for a page differs from an overall output intent for the print job;
evaluating a gamut associated with the page-level output intent and a gamut associated with the overall output intent; and
setting the page-level output intent for the page to the overall output intent if the gamut associated with the overall output intent is greater than the gamut associated with the page-level output intent.

11. The method of claim 10, further comprising discarding the page-level output intent for the page if it does not differ from the overall output intent.

12. The method of claim 10, further comprising detecting an imposed page of the plurality of pages within the print job, wherein the imposed page includes the page.

13. The method of claim 12, further comprising determining the imposed page includes multiple output intents.

14. The method of claim 13, further comprising embedding the first page and the second page in a transparency group.

15. The method of claim 14, further comprising setting an output intent for the first page and the second page as a color space for the transparency group.

16. The method of claim 10, further comprising printing the page using the page-level output intent.

17. A method for managing color printing operations within a printing system, the method comprising:
receiving a first print job having a first overall output intent and a second print job having a second overall output intent within the printing system;
processing an imposed page having the first print job and the second print job;
determining the first overall output intent for the first print job differs from the second overall output intent for the second print job;
evaluating a first gamut associated with the first overall output intent and a second gamut associated with the second overall output intent; and
setting a page-level output intent for the imposed page to the first overall output intent or the second overall output intent based on the evaluation.

18. The method of claim 17, further comprising determining a number of colors that overlap between the first overall output intent and the second overall output intent.

19. The method of claim 18, further comprising, if the number of colors that overlap do not exceed a defined threshold, comparing the first overall output intent and the second overall output intent to specified ICC profiles.

20. The method of claim 19, further comprising setting the page-level output intent for the imposed page to a color space that includes the first overall output intent and the second overall output intent.
